(19) United States
(12) Patent Application Publication
(10) Pub. No.: US 2025/0358461 A1
(43) Pub. Date: Nov. 20, 2025

(54) EVENT-BASED DYNAMIC SPONSORED CONTENT INSERTION

(71) Applicant: Charter Communications Operating, LLC, St. Louis, MO (US)

(72) Inventors: Richard J. Van Koughnett, Matthews, NC (US); David E. Agranoff, Golden, CO (US)

(21) Appl. No.: 18/666,413

(22) Filed: May 16, 2024

(51) Int. Cl. H04N 21/234; H04N 21/258; H04N 21/458

(52) U.S. Cl. CPC H04N 21/23424; H04N 21/25883; H04N 21/458

(57) ABSTRACT

Content information descriptive of a future broadcast of live multimedia content is obtained. The content information comprises a plurality of content parameters associated with the live multimedia content. Based on the content information, a sponsored content profile is generated for the future broadcast of the live multimedia content. The sponsored content profile is indicative of a plurality of sponsored content items to be provided during the future broadcast of the live multimedia content. The sponsored content profile is accessed based on a sponsored content request received from a user device. The sponsored content request comprises one or more viewing parameters associated with content being viewed at the user device. A first viewing parameter is equivalent to a first content parameter. Based on the sponsored content profile, a first sponsored content item of the plurality of sponsored content items is provided to the user device.

### BACKGROUND

Multimedia content (e.g., television shows, movies, etc.) serves as one of the most popular sources of news, art, and recreation for users in most countries in the world. Multimedia content has historically been provided to users via analog signals displayed using a television. Specifically, with the development of Cathode Ray Tube (CRT) display technology, analog signaling became the de facto technique for broadcasting multimedia content to users. Analog signaling has historically been accomplished using wired and/or wireless technologies. As an example, analog signaling can be accomplished via amplitude modulation and frequency modulation of wireless signals, which can be received by an antenna device and displayed using a television. As another example, analog signaling can be accomplished via radio frequency (RF) signals transmitted via coaxial cables, which can be received at a cable box and displayed using a television (e.g., Cable Television (CATV)).

### SUMMARY

Based on events, sponsored content can be dynamically inserted into broadcasts of live multimedia content. More specifically, a sponsored content profile can be generated for a future broadcast of live multimedia content. The sponsored content profile can indicate a number of candidate sponsored content items to be broadcast during the live multimedia content. Based on the sponsored content profile, a particular sponsored content item can be dynamically provided to a user device during the broadcast.

In one implementation, a method is provided. The method includes obtaining, by a computing system comprising one or more computing devices, content information descriptive of a future broadcast of live multimedia content, wherein the content information comprises a plurality of content parameters associated with the live multimedia content. The method further includes, based on the content information, generating, by the computing system, a sponsored content profile for the future broadcast of the live multimedia content, wherein the sponsored content profile is indicative of a plurality of sponsored content items to be provided during the future broadcast of the live multimedia content. The method further includes accessing, by the computing system, the sponsored content profile based on a sponsored content request received from a user device, wherein the sponsored content request comprises one or more viewing parameters associated with content being viewed at the user device, and wherein a first viewing parameter of the one or more viewing parameters is equivalent a first content parameter of the plurality of content parameters associated with the live multimedia content. The method further includes, based on the sponsored content profile, providing, by the computing system, a first sponsored content item of the plurality of sponsored content items to the user device.

In another implementation, a computing system is provided. The computing system includes a memory, and computing device(s) coupled to the memory. The computing device(s) are to obtain content information descriptive of a future broadcast of live multimedia content, wherein the content information comprises a plurality of content parameters associated with the live multimedia content. The computing device(s) are further to, based on the content information, generate a sponsored content profile for the future broadcast of the live multimedia content, wherein the sponsored content profile is indicative of a plurality of sponsored content items to be provided during the future broadcast of the live multimedia content. The computing device(s) are further to access the sponsored content profile based on a sponsored content request received from a user device, wherein the sponsored content request comprises one or more viewing parameters associated with content being viewed at the user device, and wherein a first viewing parameter of the one or more viewing parameters is equivalent a first content parameter of the plurality of content parameters associated with the live multimedia content. The computing device(s) are further to, based on the sponsored content profile, provide a first sponsored content item of the plurality of sponsored content items to the user device.

In another implementation, a non-transitory computer-readable storage medium is provided. The non-transitory computer-readable storage medium includes executable instructions to cause processor device(s) to obtain content information descriptive of a future broadcast of live multimedia content, wherein the content information comprises a plurality of content parameters associated with the live multimedia content. The instructions further cause the processor device(s) to, based on the content information, generate a sponsored content profile for the future broadcast of the live multimedia content, wherein the sponsored content profile is indicative of a plurality of sponsored content items to be provided during the future broadcast of the live multimedia content. The instructions further cause the processor device(s) to access the sponsored content profile based on a sponsored content request received from a user device, wherein the sponsored content request comprises one or more viewing parameters associated with content being viewed at the user device, and wherein a first viewing parameter of the one or more viewing parameters is equivalent a first content parameter of the plurality of content parameters associated with the live multimedia content. The instructions further cause the processor device(s) to, based on the sponsored content profile, provide a first sponsored content item of the plurality of sponsored content items to the user device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing event-based dynamic sponsored content insertion according to some implementations of the present disclosure.

FIG. 2 is a block diagram of an example content information obtainer for reformatting content information to obtain content parameters according to some implementations of the present disclosure.

FIG. 3 depicts a profile selector of the sponsored content handler that selects one of the sponsored content profiles based on the viewing parameters according to some implementations of the present disclosure.

FIG. 4 depicts a flow chart diagram of an example method for event-based dynamic sponsored content insertion according to some implementations of the present disclosure.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Multimedia content (e.g., television shows, movies, etc.) serves as one of the most popular sources of news, art, and recreation for users in most countries in the world. Multimedia content has historically been provided to users via analog signals displayed using a television. Specifically, with the development of Cathode Ray Tube (CRT) display technology, analog signaling became the de facto technique for broadcasting multimedia content to users. Analog signaling has historically been accomplished using wired and/or wireless technologies. As an example, analog signaling can be accomplished via amplitude modulation and frequency modulation of wireless signals, which can be received by an antenna device and displayed using a television. As another example, analog signaling can be accomplished via radio frequency (RF) signals transmitted via coaxial cables, which can be received at a cable box and displayed using a television (e.g., Cable Television (CATV)).

Multimedia content is typically provided to users by multimedia service providers. Multimedia service providers can refer to entities that own, operate, or otherwise implement network infrastructure utilized to transmit multimedia content to users. Additionally, or alternatively, in some implementations, multimedia service providers can include entities that create multimedia content (e.g., publishers, studios, etc.). Although some multimedia content is funded through subscriptions, much of the content available to users is funded via sponsored content (i.e., advertisements, etc.). Entities provide sponsored content that describes a good or service provided by the entity, which is displayed during breaks in a multimedia content broadcast. For example, an entity who wishes to inform users of a certain service offered by the entity can create sponsored content to describe the service. In exchange for funding, the sponsored content can then be inserted by a multimedia content service provider during “breaks” or pauses in multimedia content designed for sponsored content insertion. In this manner, users who are viewing the multimedia content are also likely to view the sponsored content.

Sponsored content is considered to be more “effective” (i.e., persuasive) when provided to users who belong to the “target audience” of a product or service described by the sponsored content. In other words, sponsored content can be more effective when delivered to a specific audience, or users with specific user characteristics (e.g., age, gender, interests, income, etc.). Historically, conventional analog signaling techniques have frustrated attempts by multimedia service providers to target specific user characteristics when provisioning sponsored content. For example, sponsored content inserted into a wireless analog signal carrying multimedia content is indiscriminately received by any user within range of the broadcast. Similarly, sponsored content inserted into a CATV analog signal is generally received by any user served by a particular analog network device (e.g., a repeater, switch, etc.). Without knowing which users are receiving the signal, multimedia service providers cannot reliably target users with certain characteristics.

Historically, multimedia service providers have worked with sponsored content providers to overcome this limitation by pairing sponsored content with multimedia content typically consumed by a certain type of user. For example, sponsored content describing athletic footwear might be paired with a live sports broadcast, or sponsored content describing an affordable muscle car might be paired with serialized dramas for young men. In this manner, multimedia content providers enabled rough targeting of sponsored content based on predicted associations between consuming certain types of multimedia content and utilizing certain types of goods or services. The fee associated with inserting multimedia content often varied based on the popularity and/or the predicted user associations of a particular piece of multimedia content.

Over time, digital signaling has replaced analog signaling as the primary technique to provide multimedia content to users. By representing multimedia content as a digital signal, rather than an analog signal, multimedia service providers can more efficiently compress and de-compress multimedia content, thus enabling higher fidelity signals (e.g., increased video resolution, increased sound quality, etc.). Digital signaling enables a variety of adjacent services, such as video streaming or “video-on-demand” services. In addition, the shift to digital signaling has enabled multimedia service providers to more accurately target certain user demographics.

More specifically, digital signaling enables multimedia service providers to collect viewing metadata and other information that indicates the typical characteristics of users who consume certain types of multimedia content in a privacy-preserving manner. For example, a multimedia content service provider may identify a certain television series as being particularly popular among 25-34 year old single men without identifying any specific user. Digital signaling is generally received via a computing device that processes the digital signal and displays the digital signal on a display device.

The advent of digital signaling has had a substantial impact on the manner in which sponsored content providers fund multimedia content. With analog signaling, the receiver for an analog signal is usually not a computing device that can communicate with the broadcaster, and thus cannot indicate whether sponsored content was successfully displayed to a user. Conversely, user computing devices used to consume digital multimedia content are generally configured to request sponsored content from a sponsored content server at certain times. A content “impression” is determined to occur when a request for sponsored content is successfully fulfilled (i.e., successfully delivered to a user device).

The capability to determine whether sponsored content was successfully delivered to a user has fueled a shift towards content impressions as a primary metric for selecting costs for multimedia content funding. Instead of simply inserting sponsored content within multimedia content for a particular fee, multimedia content providers instead charge sponsored content providers for a certain number of impressions. Further, in the context of television programming, impressions can be restricted to certain channel groupings that are likely to correspond with an intended audience. With the shift to digital signaling, multimedia service providers have mostly implemented impression-based content provision techniques that lack the capability to insert specific advertisements into specific pieces of multimedia content. This is because impression-based “campaigns” usually take place over extended periods of time across multiple channels or multimedia service providers. For example, assume that a sponsored content provider such as a luxury car manufacturer determines that users living in a particular county are responsible for the large majority of luxury car purchases in a state. With analog signaling techniques, sponsored content can only be targeted at a large geographic region (e.g., a state, multiple states, etc.) that includes the particular county. Conversely, with digital signaling techniques, sponsored content provided by the luxury car manufacturer can be limited to users who reside within that particular county.

Generally, the inability to target specific multimedia content is acceptable due to the advantages provided by impression-based content provision. However, in instances where real-time live content is likely to be substantially popular (e.g., national sports championships, international sporting competitions, breaking news broadcasts, televised events, etc.), the inability to target specific pieces of multimedia content can be substantially inefficient. As such, a technique to target specific pieces of multimedia content while retaining impression-based content provision capabilities is greatly desired.

Accordingly, implementations described herein propose event-based dynamic sponsored content insertion. More specifically, a computing system (e.g., a system associated with a multimedia content service provider) can obtain content information for a future broadcast of live multimedia content (e.g., a live sports broadcast, etc.). The content information can include content parameters associated with the live multimedia content, such as a title, predicted duration, channel or provider, content type, etc. Based on the content information, the computing system can generate a sponsored content profile for the future broadcast of the live multimedia content.

As described herein, a sponsored content “profile,” or “campaign,” can organize, collect, catalogue, index, etc. sponsored content items to be displayed during sponsored content “breaks” during future broadcasts. For example, assume that a live sporting event is scheduled for broadcast in one week. Sponsored content opportunities can be offered to entities that wish to broadcast sponsored content items (i.e., advertisements) to bring attention to some offering of the entity (e.g., a good or service) in exchange for a fee. As sponsored content items are obtained for future broadcast from multiple entities, a sponsored content profile can be built that organizes the received sponsored content items. The sponsored content profile can describe various characteristics of the sponsored content items (e.g., duration, originating entity, priority, minimum broadcast quantity, etc.). The sponsored content profile can also be utilized to select sponsored content items in response to sponsored content requests received from user devices.

The computing system can receive a sponsored content request from a user device. For example, assume the user device is being used to receive and display the broadcast of the live multimedia content. The broadcast can indicate that a sponsored content break is scheduled to occur. In response, the user computing device can provide the sponsored content request to the computing system. The sponsored content request can indicate various viewing parameters of the multimedia content the user computing device is being used to view (e.g., a title, start time, etc.).

Based on the sponsored content request, the computing system can access the sponsored content profile. More specifically, the computing system can access the sponsored content profile from a set of candidate profiles based on a determination that one of the viewing parameters included in the user request matches a content parameter included in the content information (e.g., a title). The computing system can provide the first sponsored content item to the user device. In such fashion, the computing system can dynamically insert sponsored content during live events.

Aspects of the present disclosure provide a number of technical effects and benefits. As one example technical effect and benefit, implementations described herein enable more effective provision of sponsored content to users. For example, conventional techniques generally lack the capability to insert sponsored content in a live event broadcast, thus rendering conventional service providers unable to effectively distribute sponsored content. However, implementations herein use content profiles generated prior to live events to successfully enable the provision of sponsored content during live event broadcasts.

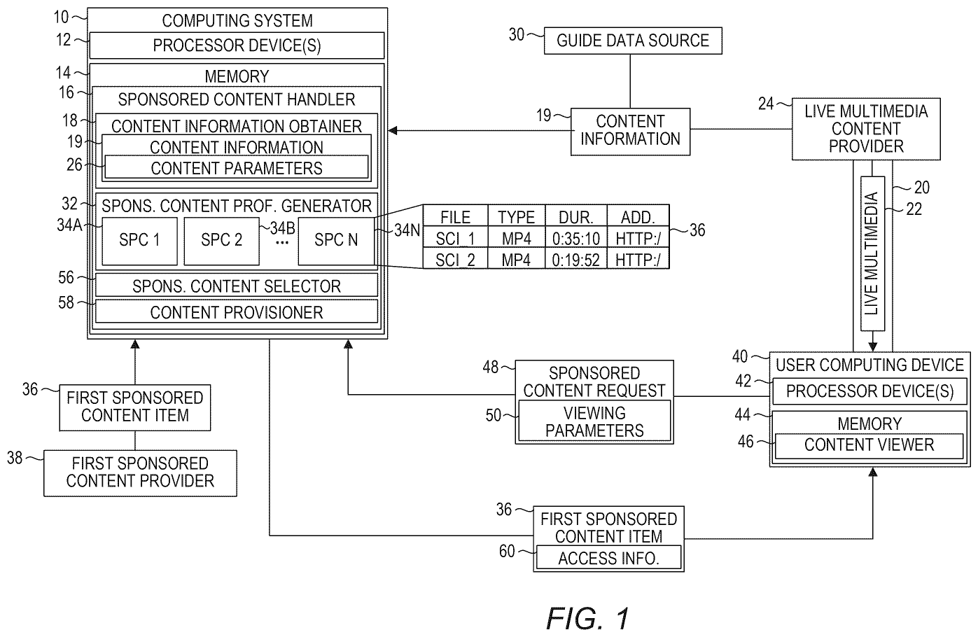

FIG. 1 is a block diagram of an environment suitable for implementing event-based dynamic sponsored content insertion according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing environment that includes multiple distributed devices and/or systems. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 14 can include a sponsored content handler 16. The sponsored content handler 16 can handle obtainment, insertion, modification, etc. of sponsored content. As described herein, sponsored content generally refers to content that describes a particular good or service offered by the provider of the sponsored content. For example, a luxury automobile manufacturer may create sponsored content to describe various features of a new model of an automobile.

Sponsored content is generally inserted into multimedia content by a multimedia content service provider. As described herein, a “multimedia content service provider” can refer to entities that own, operate, or otherwise implement network infrastructure utilized to transmit multimedia content to users. For example, the computing system 10 can be, or can be included in, the computing environment implemented by a multimedia content service provider (e.g., network devices (e.g., routers, switches, etc.), cloud devices, virtualized devices, etc.). Additionally, or alternatively, in some instances, multimedia service providers can include entities that create multimedia content (e.g., publishers, studios, etc.).

The sponsored content handler 16 can include a content information obtainer 18. The content information obtainer 18 can obtain content information 19 for a future broadcast 20 of live multimedia content 22. For example, assume that the live multimedia content 22 is a live sports event planned for the next day. The future broadcast 20 can be scheduled for a particular time the next day (e.g., the time that the live sports event starts), and the future broadcast 20 can be performed by a live multimedia content provider 24 (e.g., a cable television station, a public television station, a streaming service, etc.).

The content information 19 can describe the live multimedia content 22. More specifically, the content information 19 can describe various characteristics or predicted characteristics of the live multimedia content 22 to be broadcast during the future broadcast 20, such as a title, a content type (e.g., a serialized television show, a live sports broadcast, etc.), a start time, a predicted end time, etc.

In some implementations, the content information 19 can include content parameters 26. Additionally, or alternatively, in some implementations, the content information obtainer 18 can derive the content parameters 26 from the content information 19. For example, if the content information 19 is a structured data object, the content information obtainer 18 can extract the content parameters 26 and their corresponding values from the structured data object. The content parameters 26 can include set parameters with corresponding values descriptive of the characteristics of the live multimedia content 22.

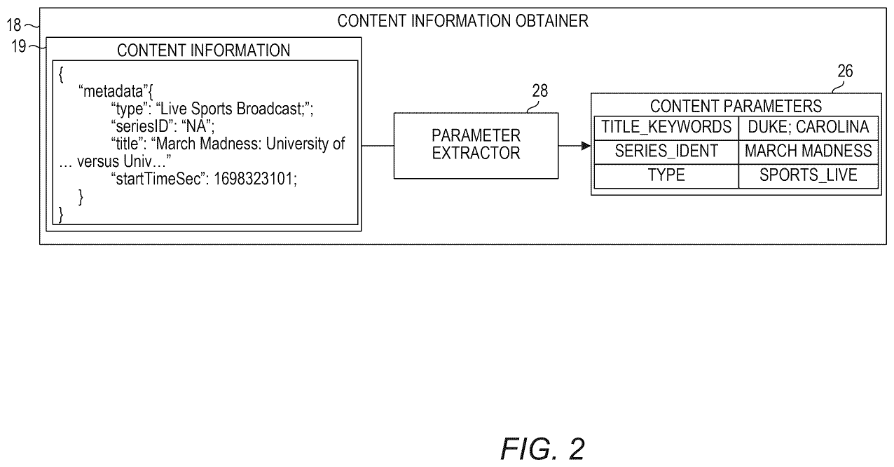

For a specific example, turning to FIG. 2, FIG. 2 is a block diagram of an example content information obtainer for reformatting content information to obtain content parameters according to some implementations of the present disclosure. More specifically, the content information obtainer 18 can obtain the content information 19. To follow the depicted example, the content information 19 can be a structured data object (e.g., a Javascript Object Notation (JSON) object, etc.) that includes the content parameters 26 and corresponding values.

The content information obtainer 18 can include a parameter extractor 28 configured to extract the content parameters 26 from the content information 19. Upon extraction, the content parameters 26 can describe various characteristics of the live multimedia content 22 to be broadcast during the future broadcast 20.

For example, the content information 19 can be a structured data object with a title field and corresponding value of “University of . . . versus Univ. . . .” The parameter extractor 28 can process the content information 19 to extract a “TITLE_KEYWORDS” parameter and a corresponding value of “Duke; Carolina.” For another example, the content information 19 can have a type field and corresponding value of “Live Sports Broadcast.” The parameter extractor 28 can process the content information 19 to extract a “TYPE” parameter and a corresponding value of “SPORTS_LIVE.” In this manner, the parameter extractor 28 can “re-format” the content information 19 so that it can be utilized by the computing system 10 and other devices within the same environment.

Returning to FIG. 1, in some implementations, at least some of the content information 19 can be obtained from the live multimedia content provider 24. For example, assume that the live multimedia content provider 24 is a network television station who has purchased rights to broadcast the live multimedia content 22. Further assume that the live multimedia content 22 is a sports tournament between teams that have not yet been decided. Once the teams have been decided, the live multimedia content provider 24 can provide a portion of the content information 19 to the computing system 10 that describes the decided teams.

Alternatively, in some implementations, the content information can be obtained from a guide data source 30. The guide data source 30 can be a programming service provider that provides information describing planned broadcasts and live events. In some implementations, the guide data source 30 can be a third-party service provider that provides the content information to the computing system 10. Alternatively, in some implementations, the guide data source 30 can be an internal repository within the same computing environment as the computing system 10 (e.g., a computing environment implemented by a multimedia content service provider).

The sponsored content handler 16 can include a sponsored content profile generator 32. The sponsored content profile generator 32 can generate sponsored content profiles 34A-34N (generally, sponsored content profiles 34). Each of the sponsored content profiles 34 can describe items of sponsored content to be inserted into corresponding live events, or future broadcasts of live multimedia. For example, assume that the sponsored content profile 34N is a generated by the sponsored content profile generator 32 for the live multimedia content 22. To follow the depicted example, the sponsored content profile can describe a first sponsored content item 36 with a file name of “SCI_1”, a file type of “.MP4”, and a duration of 0:35:10. The sponsored content profile can also describe a second sponsored content item 37 with a file name of “SCI_2”, a file type of “.MP4”, and a duration of 0:19:52. In some implementations, the sponsored content profile 34N can include a file location at which the first sponsored content item 36 can be accessed.

More specifically, the sponsored content profile generator 32 can generate “profiles” or “campaigns” for delivery of sponsored content to users during broadcasts of particular events, such as live events. For example, assume that a live event is scheduled to occur in the future. Prior to the live event being broadcast, a service provider associated with the computing system 10 (e.g., a network service provider, a cable television service provider, an audiovisual streaming service provider, an Internet Protocol (IP) television service provider, etc.) can reach out to entities who may be willing to provide some cost or fee in exchange for broadcasting a sponsored content item provided by the entity. For example, an automobile manufacturing entity may create a 30-second audiovisual sponsored content item that describes the benefits of a new automobile offering. In exchange for some fee or cost, the service provider can agree to broadcast the sponsored content item during the broadcast of the live event.

As sponsored content items are received by the service provider, the sponsored content profile generator 32 can generate a sponsored content profile for the live event that catalogs the received sponsored content items. To follow the previous example, the sponsored content profile can indicate a duration of the sponsored content item, the entity that provided the sponsored content item, a description of the sponsored content item, a file location for the sponsored content item, etc. In this manner, the sponsored content profiles created using the sponsored content profile generator 32 can be utilized to make dynamic sponsored content insertion decisions during live event broadcasts.

In some implementations, the first sponsored content item 36 can be obtained from a first sponsored content provider 38. The first sponsored content item 36 can describe some good or service offered by the first sponsored content provider 38. For example, if the first sponsored content provider 38 makes sports equipment, the first sponsored content item 36 can describe various features of the sports equipment made by the first sponsored content provider 38.

After the sponsored content profile 34N is generated, the future broadcast 20 of the live multimedia content 22 can occur. The live multimedia content provider 24 can perform the broadcast 20, which can be received by a user computing device 40. The user computing device 40 can include processor device(s) 42 and a memory 44 as described with regards to the processor device(s) 12 and the memory 14 of the computing system 10, respectively. The user computing device 40 can be any type or manner of device sufficient to receive and display the broadcast 20 of the live multimedia content 22, such as a smartphone, laptop computer, desktop computer, cable box, smart television, Mixed Reality (MR) device, etc.

The memory 44 of the user computing device 40 can include a content viewer 46. The content viewer 46 can handle receipt and display of the live multimedia content 22 as configured by the multimedia content service provider associated with the computing system 10. More specifically, upon determining that a break in the broadcast 20 has occurred for insertion of sponsored content, the content viewer 46 can provide a sponsored content request 48 to the computing system 10.

The sponsored content request 48 can request that sponsored content be provided to the user computing device 40 for display within the break in the broadcast 20 for insertion of sponsored content. In response, the sponsored content handler 16 can select a sponsored content item from a number of candidate sponsored content items. For example, as described previously, the sponsored content profile 34N describes the first sponsored content item 36 and the second sponsored content item 37. The sponsored content handler 16 can select between the first sponsored content item 36 and the second sponsored content item 37 for provision to the user computing device 40.

In some implementations, the sponsored content request 48 can include viewing parameters 50. The viewing parameters 50 can describe the content currently being viewed via the content viewer 46 (e.g., the live multimedia content 22). For example, the viewing parameters 50 can include a displayed title, starting view time, viewing duration, etc. The sponsored content handler 16 can identify one of the sponsored content profiles 34 based on the viewing parameters 50.

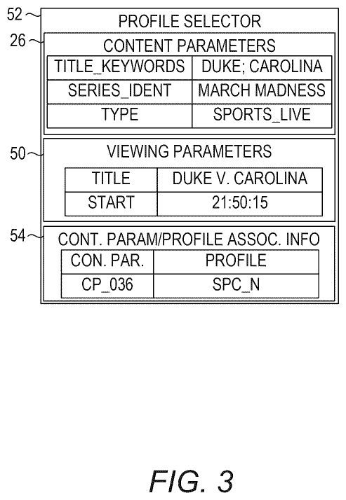

For a specific example, turning to FIG. 3, FIG. 3 depicts a profile selector of the sponsored content handler 16 that selects one of the sponsored content profiles 34 based on the viewing parameters 50 according to some implementations of the present disclosure. More specifically, profile selector 52 can determine that at least one of the viewing parameters 50 matches, or is otherwise equivalent to, one of the content parameters 26. To follow the depicted example, the profile selector 52 can determine that the title parameter of the viewing parameters 50 (e.g., “TITLE: DUKE V. CAROLINA”) is equivalent to the title parameter of the content parameters 26 (e.g., “TITLE_KEYWORDS: DUKE; CAROLINA”).

The profile selector 52 can include content parameter/profile association information 54. The content parameter/profile association information 54 can indicate an association between certain content parameters and corresponding profiles of the sponsored content profiles 34. Specifically, the content parameter/profile association information 54 can indicate an association between the content parameters 26 and the sponsored content profile 34N. Based on the content parameter/profile association information 54, the profile selector 52 can select the sponsored content profile 34N.

Returning to FIG. 1, the sponsored content handler 16 can include a sponsored content selector 56. The sponsored content selector 56 can select sponsored content to provision to the user computing device 40 based on the sponsored content profile 34N selected by the profile selector 52. More specifically, the sponsored content selector 56 can select either the first sponsored content item 36 or the second sponsored content item 38 described by the sponsored content profile 34N.

The sponsored content selector 56 can select the sponsored content based on any type or manner of information, such as characteristics of a user of the user computing device 40. For example, assume that the sponsored content profile 34N includes target characteristic information (not illustrated) that describes target user characteristics for users to be provisioned with the first sponsored content item 36 (e.g., a certain gender, educational status, etc.). Further assume that the sponsored content request 48 indicates user characteristics of the user of the user computing device 40 (e.g., gender, educational status, etc.). If the target user characteristics described by the target characteristic information match the user characteristics described by the sponsored content request 48, the sponsored content selector 56 can select the sponsored content.

The sponsored content handler 16 can include a content provisioner 58. The content provisioner 58 can provision the first sponsored content item 36 to the user computing device 40. For example, the content provisioner 58 can directly provide the first sponsored content item 36 to the user computing device via digital wireless signaling. For another example, the content provisioner 58 can instruct the first sponsored content provider to provide the first sponsored content item 36 to the user computing device 40 (e.g., via wireless digital signaling, etc.). For yet another example, the content provisioner 58 may provide access information 60 to the user computing device 40 that includes the access address for the first sponsored content item 36 described by the sponsored content profile 34N.

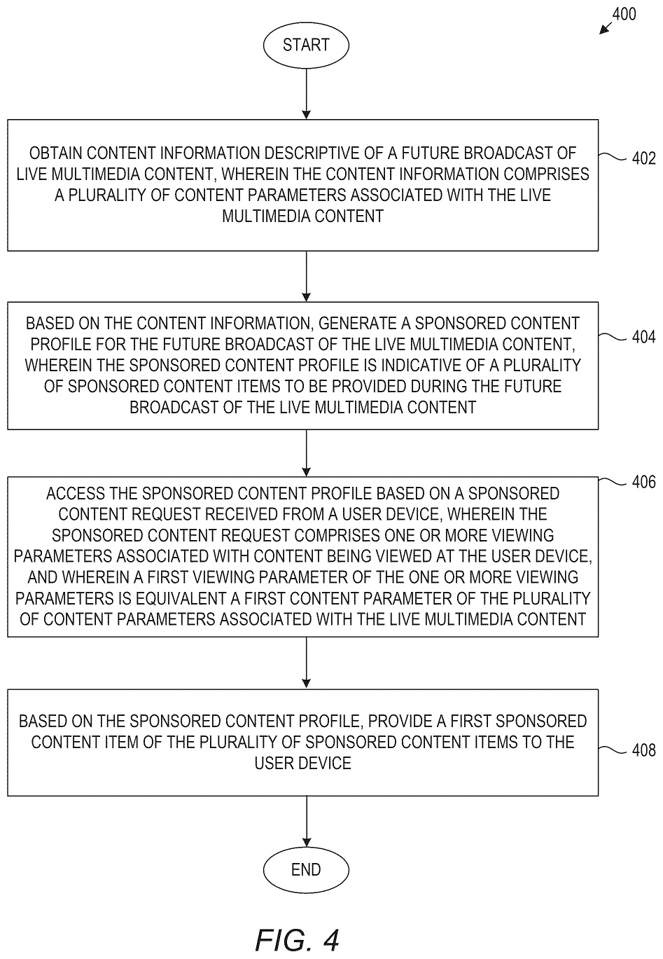

FIG. 4 depicts a flow chart diagram of an example method 400 for event-based dynamic sponsored content insertion according to some implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can obtain content information descriptive of a future broadcast of live multimedia content. The content information can include a plurality of content parameters associated with the live multimedia content.

At 404, the computing system can, based on the content information, generate a sponsored content profile for the future broadcast of the live multimedia content. The sponsored content profile can be indicative of a plurality of sponsored content items to be provided during the future broadcast of the live multimedia content. In some implementations, generating the sponsored content profile can include obtaining the first sponsored content item and target characteristic information from a computing system associated with a sponsored content provider. The target characteristic information can be descriptive of a plurality of target user characteristics.

At 406, the computing system can access the sponsored content profile based on a sponsored content request received from a user device. The sponsored content request can include one or more viewing parameters associated with content being viewed at the user device. A first viewing parameter of the one or more viewing parameters can be equivalent a first content parameter of the plurality of content parameters associated with the live multimedia content.

In some implementations, accessing the sponsored content profile based on the sponsored content request received from the user device can include selecting the first sponsored content item of the plurality of sponsored content items based on the sponsored content request. In some implementations, prior to accessing the sponsored content profile, the computing system can make a determination that the first viewing parameter is equivalent to the first content parameter of the plurality of content parameters associated with the live multimedia content. The computing system can identify the sponsored content profile from a plurality of candidate sponsored content profiles based on the determination.

In some implementations, the first viewing parameter that is equivalent to the first content parameter comprises a title for the live multimedia content. Alternatively, in some implementations, the first viewing parameter that is equivalent to the first content parameter comprises a broadcast channel for the live multimedia content.

In some implementations, prior to accessing the sponsored content profile, the computing system can receive the sponsored content request from the user device. The sponsored content request can be descriptive of a plurality of user characteristics for a user of the user device.

At 408, the computing system can, based on the sponsored content profile, provide a first sponsored content item of the plurality of sponsored content items to the user device. In some implementations, providing the first sponsored content item of the plurality of sponsored content items to the user device can include making a determination that one or more of the plurality of user characteristics respectively match one or more target user characteristics of the plurality of target user characteristics. The computing system can select the first sponsored content item of the plurality of sponsored content items based on the determination. In some implementations, the one or more target user characteristics can include at least one of a gender characteristic, an age characteristic, a geographic location characteristic, or a predicted income characteristic.

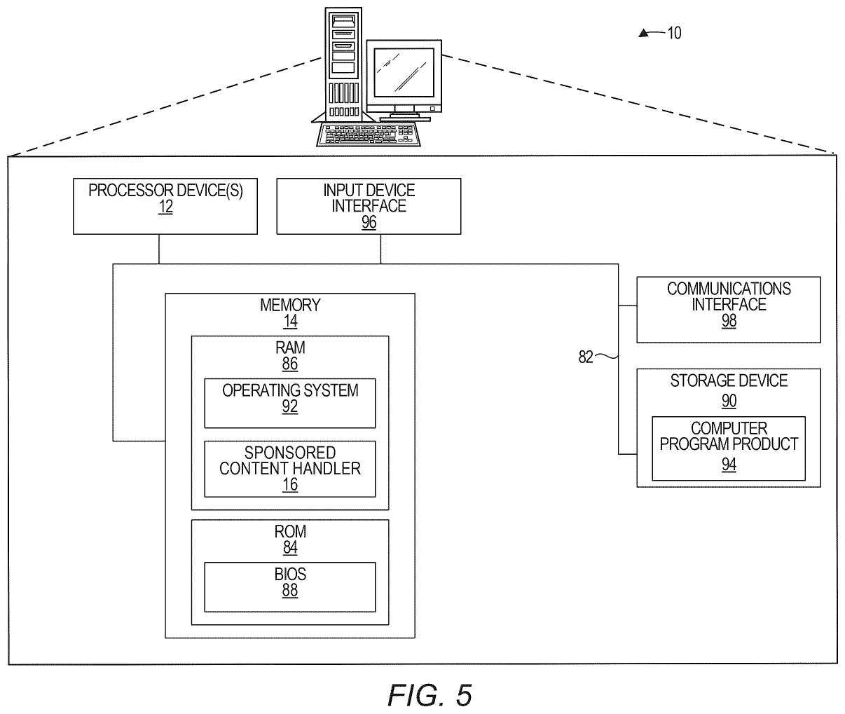

FIG. 5 is a block diagram of the computing system 10 suitable for implementing examples according to one example. The computing system 10 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 10 includes the processor device(s) 12, the memory 14, and a system bus 82. The system bus 82 provides an interface for system components including, but not limited to, the memory 14 and the processor device(s) 12. The processor device(s) 12 can be any commercially available or proprietary processor.

The system bus 82 may be any of several types of bus structures that may further interconnect to a memory bus (with or without a memory controller), a peripheral bus, and/or a local bus using any of a variety of commercially available bus architectures. The memory 14 may include non-volatile memory 84 (e.g., read-only memory (ROM), erasable programmable read-only memory (EPROM), electrically erasable programmable read-only memory (EEPROM), etc.), and volatile memory 86 (e.g., random-access memory (RAM)). A basic input/output system (BIOS) 88 may be stored in the non-volatile memory 84 and can include the basic routines that help to transfer information between elements within the computing system 10. The volatile memory 86 may also include a high-speed RAM, such as static RAM, for caching data.

The computing system 10 may further include or be coupled to a non-transitory computer-readable storage medium such as the storage device 90, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 90 and other drives associated with computer-readable media and computer-usable media may provide non-volatile storage of data, data structures, computer-executable instructions, and the like.

A number of modules can be stored in the storage device 90 and in the volatile memory 86, including an operating system 92 and one or more program modules, such as the sponsored content handler 16, which may implement the functionality described herein in whole or in part. All or a portion of the examples may be implemented as a computer program product 94 stored on a transitory or non-transitory computer-usable or computer-readable storage medium, such as the storage device 90, which includes complex programming instructions, such as complex computer-readable program code, to cause the processor device(s) 12 to carry out the steps described herein. Thus, the computer-readable program code can comprise software instructions for implementing the functionality of the examples described herein when executed on the processor device(s) 12. The processor device(s) 12, in conjunction with the sponsored content handler 16 in the volatile memory 86, may serve as a controller, or control system, for the computing system 10 that is to implement the functionality described herein.

Because the sponsored content handler 16 is a component of the computing system 10, functionality implemented by the sponsored content handler 16 may be attributed to the computing system 10 generally. Moreover, in examples where the sponsored content handler 16 comprises software instructions that program the processor device 12 to carry out functionality discussed herein, functionality implemented by the sponsored content handler 16 may be attributed herein to the processor device(s) 12.

An operator, such as the user, may also be able to enter one or more configuration commands through a keyboard (not illustrated), a pointing device such as a mouse (not illustrated), or a touch-sensitive surface such as a display device. Such input devices may be connected to the processor device(s) 12 through an input device interface 96 that is coupled to the system bus 82 but can be connected by other interfaces such as a parallel port, an Institute of Electrical and Electronic Engineers (IEEE) 1394 serial port, a Universal Serial Bus (USB) port, an IR interface, and the like. The computing system 10 may also include the communications interface 98 suitable for communicating with the network as appropriate or desired. The computing system 10 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a computing system comprising one or more computing devices, content information descriptive of a future broadcast of live multimedia content, wherein the content information comprises a plurality of content parameters associated with the live multimedia content;
based on the content information, generating, by the computing system, a sponsored content profile for the future broadcast of the live multimedia content, wherein the sponsored content profile is indicative of a plurality of sponsored content items to be provided during the future broadcast of the live multimedia content;
accessing, by the computing system, the sponsored content profile based on a sponsored content request received from a user device, wherein the sponsored content request comprises one or more viewing parameters associated with content being viewed at the user device, and wherein a first viewing parameter of the one or more viewing parameters is equivalent a first content parameter of the plurality of content parameters associated with the live multimedia content; and
based on the sponsored content profile, providing, by the computing system, a first sponsored content item of the plurality of sponsored content items to the user device.

2. The method of claim 1, wherein accessing the sponsored content profile based on the sponsored content request received from the user device further comprises:
selecting, by the computing system, the first sponsored content item of the plurality of sponsored content items based on the sponsored content request.

3. The method of claim 2, wherein, prior to accessing the sponsored content profile, the method comprises:
making, by the computing system, a determination that the first viewing parameter is equivalent to the first content parameter of the plurality of content parameters associated with the live multimedia content; and
identifying, by the computing system, the sponsored content profile from a plurality of candidate sponsored content profiles based on the determination.

4. The method of claim 3, wherein the first viewing parameter that is equivalent to the first content parameter comprises a title for the live multimedia content.

5. The method of claim 3, wherein the first viewing parameter that is equivalent to the first content parameter comprises a broadcast channel for the live multimedia content.

6. The method of claim 2, wherein generating the sponsored content profile comprises:
obtaining, by the computing system, the first sponsored content item and target characteristic information from a computing system associated with a sponsored content provider, wherein the target characteristic information is descriptive of a plurality of target user characteristics.

7. The method of claim 6, wherein, prior to accessing the sponsored content profile, the method comprises:
receiving, by the computing system, the sponsored content request from the user device, wherein the sponsored content request is descriptive of a plurality of user characteristics for a user of the user device.

8. The method of claim 6, wherein providing the first sponsored content item of the plurality of sponsored content items to the user device comprises:
making, by the computing system, a determination that one or more of the plurality of user characteristics respectively match one or more target user characteristics of the plurality of target user characteristics; and
selecting, by the computing system, the first sponsored content item of the plurality of sponsored content items based on the determination.

9. The method of claim 8, wherein the one or more target user characteristics comprises at least one of:
a gender characteristic;
an age characteristic;
a geographic location characteristic; or
a predicted income characteristic.

10. A computing system, comprising:
one or more computing devices to:
obtain content information descriptive of a future broadcast of live multimedia content, wherein the content information comprises a plurality of content parameters associated with the live multimedia content;
based on the content information, generate a sponsored content profile for the future broadcast of the live multimedia content, wherein the sponsored content profile is indicative of a plurality of sponsored content items to be provided during the future broadcast of the live multimedia content;
access the sponsored content profile based on a sponsored content request received from a user device, wherein the sponsored content request comprises one or more viewing parameters associated with content being viewed at the user device, and wherein a first viewing parameter of the one or more viewing parameters is equivalent a first content parameter of the plurality of content parameters associated with the live multimedia content; and
based on the sponsored content profile, provide a first sponsored content item of the plurality of sponsored content items to the user device.

11. The computing system of claim 10, wherein accessing the sponsored content profile based on the sponsored content request received from the user device further comprises:
selecting the first sponsored content item of the plurality of sponsored content items based on the sponsored content request.

12. The computing system of claim 11, wherein, prior to accessing the sponsored content profile, the one or more computing devices are to:
make a determination that the first viewing parameter is equivalent to the first content parameter of the plurality of content parameters associated with the live multimedia content; and
identify the sponsored content profile from a plurality of candidate sponsored content profiles based on the determination.

13. The computing system of claim 12, wherein the first viewing parameter that is equivalent to the first content parameter comprises a title for the live multimedia content.

14. The computing system of claim 12, wherein the first viewing parameter that is equivalent to the first content parameter comprises a broadcast channel for the live multimedia content.

15. The computing system of claim 11, wherein generating the sponsored content profile comprises:
obtaining the first sponsored content item and target characteristic information from a computing system associated with a sponsored content provider, wherein the target characteristic information is descriptive of a plurality of target user characteristics.

16. The computing system of claim 15, wherein, prior to accessing the sponsored content profile, the one or more computing devices are to:
receive the sponsored content request from the user device, wherein the sponsored content request is descriptive of a plurality of user characteristics for a user of the user device.

17. The computing system of claim 16, wherein providing the first sponsored content item of the plurality of sponsored content items to the user device comprises:
making a determination that one or more of the plurality of user characteristics respectively match one or more target user characteristics of the plurality of target user characteristics; and
selecting the first sponsored content item of the plurality of sponsored content items based on the determination.

18. The computing system of claim 17, wherein the one or more target user characteristics comprises at least one of:
a gender characteristic;
an age characteristic;
a geographic location characteristic; or
a predicted income characteristic.

19. A non-transitory computer-readable storage medium that includes executable instructions to cause one or more processor devices to:
obtain content information descriptive of a future broadcast of live multimedia content, wherein the content information comprises a plurality of content parameters associated with the live multimedia content;
based on the content information, generate a sponsored content profile for the future broadcast of the live multimedia content, wherein the sponsored content profile is indicative of a plurality of sponsored content items to be provided during the future broadcast of the live multimedia content;
access the sponsored content profile based on a sponsored content request received from a user device, wherein the sponsored content request comprises one or more viewing parameters associated with content being viewed at the user device, and wherein a first viewing parameter of the one or more viewing parameters is equivalent a first content parameter of the plurality of content parameters associated with the live multimedia content; and
based on the sponsored content profile, provide a first sponsored content item of the plurality of sponsored content items to the user device.

20. The non-transitory computer-readable storage medium of claim 19, wherein accessing the sponsored content profile based on the sponsored content request received from the user device further comprises:
selecting the first sponsored content item of the plurality of sponsored content items based on the sponsored content request.
